(19) United States
(12) Patent Application Publication
(10) Pub. No.: US 2006/0215217 A1
(43) Pub. Date: Sep. 28, 2006

(54) Image forming system, image forming method and image reading device

(75) Inventor: Yasushi Ujigawa, Saitama (JP)

Correspondence Address: OLIFF & BERRIDGE, PLC, P.O. BOX 19928, ALEXANDRIA, VA, 22320, US

(73) Assignee: FUJI XEROX CO., LTD., Minato-ku (JP)

(21) Appl. No.: 11/185,712

(22) Filed: Jul. 21, 2005

(30) Foreign Application Priority Data
Mar. 22, 2005 (JP) 2005-081692

(51) Int. Cl. G06F 3/12

(52) U.S. Cl. 358/1.15; 358/1.13

(57) ABSTRACT

An image forming system including an image reading device and a printing device which are connected together through a communication unit, for transmitting image data read by the image reading device to the printing device through the communication unit to print out, in which the image reading device obtains a print image data format processable by the printing device and, when printing by a selected printing device the image data read by the image reading device, converts the image data into a print image data format optimum for the selected printing device by referring to the obtained print image data format and, in which the printing device receives the converted image data and performs printing processing.

### BACKGROUND OF THE INVENTION

1. Field of the Invention

The present invention relates to an image forming system, an image forming method and an image reading device for forming image data that demands a connected printer to perform printing, and more particularly to an image forming system, an image forming method and an image reading device capable of generating optimum image data corresponding to a printer for printing out.

2. Description of the Related Art

Generally, the printer prints out image data which is generated according to a color data format which is called color signal arrangement. Individual pixels of image data of the color signal arrangement are indicated by an assembly of color components, and there are point sequence, line sequence and plane sequence as arrangement modes indicating manners of showing the components. Specifically, image data generated according to any of the color data formats can be printed.

The printers include a printer which supports plural color data formats and a printer which supports only one color data format. Even the printer which supports plural color data formats has different combinations and different numbers of color data formats. Therefore, to print out by the designated printer, it is necessary to make a print request by transferring the image data generated in the color data format supported by the pertinent printer.

Here, an example of color data format arrangement will be described with reference to FIG. 9A through FIG. 9D.

The point sequence which is a color data format is a data format to sequentially arrange individual colors (color component) of YMCK (Yellow Magenta Cyan Key color (black)) process colors as shown in FIG. 9B and arranged as “width (4*A) dot×length B dot” when a document having “width A pixel×length B pixel” as shown in FIG. 9A is arranged in the point sequence.

The line sequence is a data format having the individual color components of YMCK line-arranged for individual components as shown in FIG. 9C and arranged in “width A dot×length (4*B) dot” similar to the point sequence when the document shown in FIG. 9A is arranged in the line sequence.

And, the plane sequence is a data format having the individual color components of YMCK arranged for every plane as shown in FIG. 9D and arranged in “width A dot×length (4*B) dot” similar to the point sequence when the document shown in FIG. 9A is arranged in the plane sequence.

To print out as described above, it is necessary to generate image data according to an appropriate color data format.

There is prior art which prevents a transmission error to a server computer which does not support an image format by considering an image format of image data or the like pictured by a digital camera disclosed in Japanese Patent Laid-Open Publication No. 2003-116089.

The prior art disclosed in Japanese Patent Laid-Open Publication No. 2003-116089 selects image data generated in a non-general-purpose format from image data generated in general-purpose format and non-general-purpose format and, when a service involving the reproduction of the image data is used, controls the image data to send to a server computer. For image data in a format not supported by the server computer, RAW data, which generates the output from an image pickup device substantially as it is, is sent.

But, the prior art described in Japanese Patent Application Laid-Open No. 2003-116089 is configured such that image data which is generated in a general-purpose format indicating a general image format is sent in the pertinent general-purpose format to the server computer but RAW data is sent for others. But, it has a disadvantage that image data cannot be reproduced in a data format corresponding to the properties of the server computer.

### SUMMARY OF THE INVENTION

The present invention has been made in view of the above circumstances and provides an image forming system, an image forming method and an image reading device capable of transferring image data formed in a color data format in accordance with the properties of a desired printer.

An aspect of the present invention provides an image forming system including an image reading device and a printing device which are connected together through a communication unit, for transmitting image data read by the image reading device to the printing device through the communication unit to print out, in which the image reading device includes: an information acquisition unit which obtains a print image data format processable by the printing device through the communication unit; a management unit which stores and manages the print image data format obtained by the information acquisition unit in correspondence with the printing device; a selection unit which selects a printing device which instructs to print the image data read by the image reading device; a conversion unit which refers to the print image data format managed by the management unit and converts the image data read by the image reading device into a print image data format optimum for the printing device selected by the selection unit; and a transmission unit which sends the image data in the print image data format converted by the conversion unit to the printing device through the communication unit, and in which the printing device includes: a receiving unit which receives the image data sent by the transmission unit; and a print processing unit which performs printing according to the image data received by the receiving unit.

According to the above-mentioned aspect of the present invention, it is configured such that color data format information and printer specific information including compression format information are obtained from the selected printer and stored in the memory, the data format of the read image data is converted according to the stored information to generate image data, and the image data is compressed in a compression format to generate an image. Therefore, the present invention exerts an effect that printing can be made using a desired printer without being conscious of the specifications of the individual connected printers.

### BRIEF DESCRIPTION OF THE DRAWINGS

FIG. 1 is a view of a system structure configured by applying an image forming system, an image forming method and an image reading device of the present invention;

FIG. 2 is a view showing a structure of a scanner which is an image forming device of the present invention;

FIG. 3 is a flow chart showing a flow of processing to generate an image by a scanner;

FIG. 4 is a flow chart showing a flow of processing to make automatic determination of a color data format of a scanner;

FIG. 5 is a flow chart showing a flow of processing to make automatic determination of a compression format of a scanner;

FIG. 6A, FIG. 6B and FIG. 6C are views showing an example of color processing information to decide a color data format;

FIG. 7 is a view showing an example of color processing information to decide a compression format;

FIG. 8 is a view of another system structure example configured by applying an image forming system, an image forming method and an image reading device according to the present invention; and

FIG. 9A through FIG. 9D are views showing arrangement structures of color data formats.

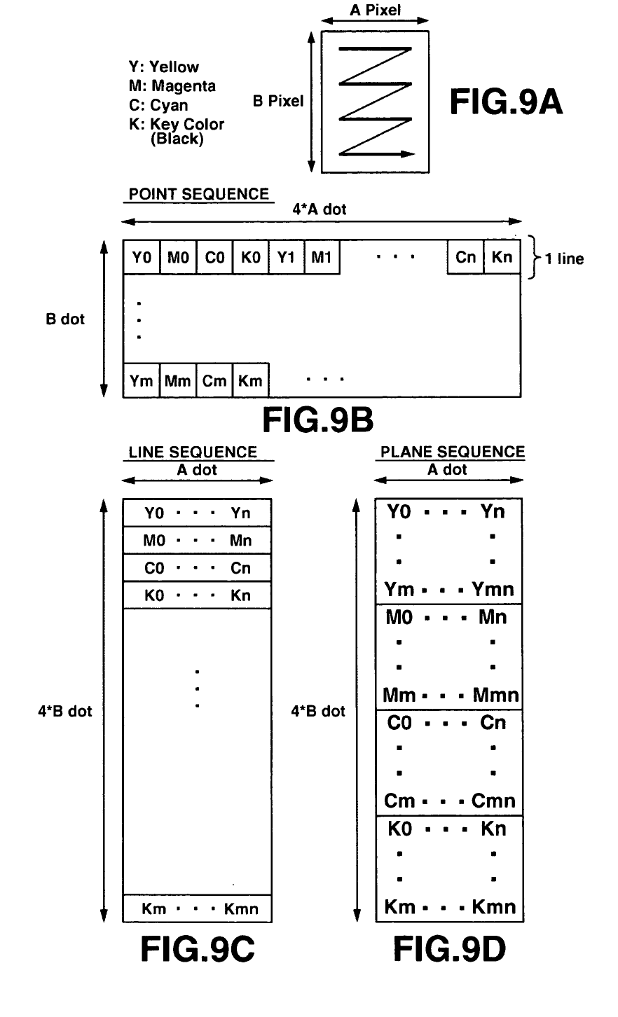

### DETAILED DESCRIPTION OF THE INVENTION

Embodiments of an image forming system, an image forming method and an image reading device according to the present invention will be described in detail with reference to the accompanying drawings.

### Embodiment 1

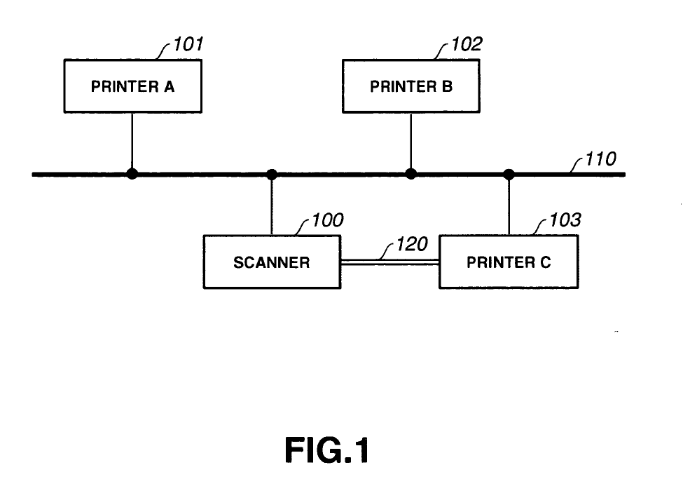

FIG. 1 is a view of a system structure configured by applying the image forming system, the image forming method and the image reading device of the present invention.

In FIG. 1, this image forming system is comprised of a scanner 100, a printer A101, a printer B102 and a printer C103, and they are connected through an Ethernet (registered trademark) cable 110. The scanner 100 and the printer C103 are also connected by a P2P connection (Peer to Peer) through a USB (Universal Serial Bus) cable 120.

Specifically, the scanner 100 and the printer C103 realize a network connection through the Ethernet (registered trademark) cable 110 and a local connection through the USB cable 120.

The scanner 100 can read printed documents, sends and receives data to and from the printers, obtains a print image data format corresponding to the printer selected by a user through a co-disposed operation panel from the pertinent printer and stores it in an internal storage area. The print image data format includes a color data format and a compression format which are image formats which can be interpreted by the individual printers and forms image data in the pertinent color data format. The color data format here includes “point sequence”, “plane sequence” and “line sequence”.

The printer selectable through the operation panel is a printer connected by the network connection or the local connection, and in the example shown in FIG. 1, any of the printer A101, the printer B102 and the printer C103 can be selected. And, the scanner 100 can compress in a prescribed compression format.

The printer A101, the printer B102 and the printer C103 can receive instruction data from the scanner, transfer a print image data format according to the received instruction data to the scanner and print out the image data received from the scanner.

In this case, when image data formed in a format other than the color data formats corresponding to the individual printers is requested to be printed, the image data cannot be analyzed, so that a print error is caused.

When a print request is made to a printer which does not conform to the compression of image data to print the compressed image data, the printer cannot decompress or analyze the compressed image data, so that a print error is caused in the same manner as above.

It becomes possible to printout without awareness of the specifications of the printer selected from the scanner 100 by forming image data according to the color data format and compression format obtained from the printer.

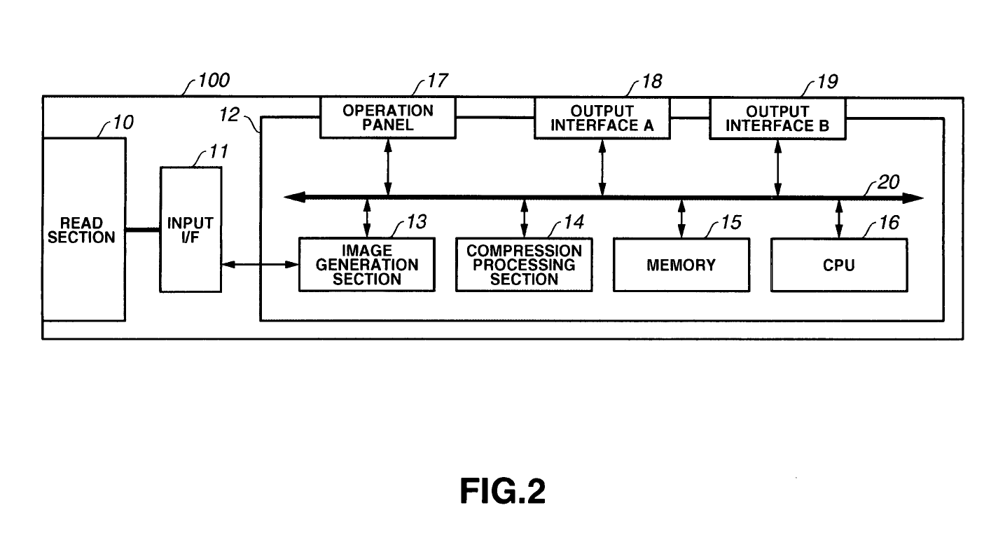

FIG. 2 is a view showing a structure of a scanner which is an image forming device of the present invention.

The scanner 100 shown in FIG. 2 is comprised of a read section 10, an input interface 11 and a scanner controller 12. The read section 10 reads printed documents to create image data, and the input interface 11 provides a bridge function for the read section 10 and the scanner controller 12. The scanner controller 12 controls reading executed by the scanner 100.

The scanner controller 12 is further comprised of an image generation section 13 which is connected by a general-purpose bus 20 which is a data transmission path, a compression processing section 14, a memory 15, a CPU (Central Processing Unit) 16, an operation panel 17, an output interface A18 and an output interface B 19.

The image generation section 13 accepts the image data received from the input interface 11 and generates image data according to the printer specific information stored in the memory. The image data generated is also stored in the memory 15 simultaneously.

The printer specific information includes printer color processing information indicating a color data format of image data to be printed out other than print setting information, device information and network identification information. The color data format includes “point sequence”, “plane sequence” and “line sequence”. The image generation section 13 generates image data in a color format of the printer color processing information obtained from the selected printer.

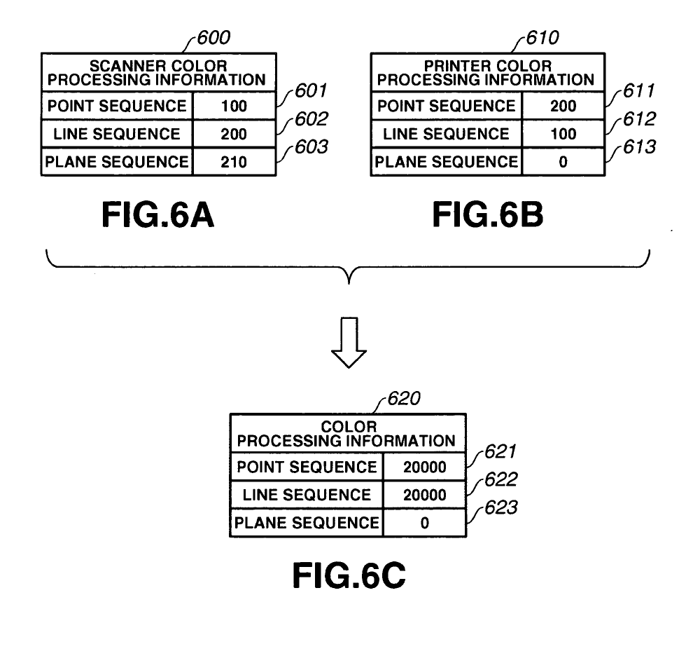

Some printers may conform to plural color data formats. Then, image data is generated in the color data format which is selected as optimum color data format among the conforming color data formats. As a selection method here, there is a method to decide by selecting a color data format with less weighting by making quantified weighting of the color data format to which the printer conforms. An example of this case is shown in FIGS. 6A to 6C.

The compression processing section 14 compresses the image data generated by the image generation section 13 in the compression format of the printer stored in the memory 15 and stores the compressed image data in the memory 15. The image data compression processing is not executed if the compression format stored in the memory 15 is “RAW” indicating noncompression.

The compression format includes a JPEG (Joint Photographic Experts Group) format which is an irreversible method intended for effective use of a storage area resource and transfer improvement by decreasing a data size even though the image quality is degraded, a PackBits format which is a reversible method intended for giving a priority on the image quality and capable of properly reproducing data, and the like. The data size can be made smaller than the read image data by compressing.

The memory 15 indicates a ROM (Read Only Memory), a RAM (Random Access Memory) or the like and stores a program and various parameters to perform a read operation. Besides, the memory 15 stores specific information including information of the color data format obtained from the printer selected by the user and information of the compression format and also stores the image data generated by the image generation section 13 and the image data compressed by the compression processing section 14.

As a parameter, scanner color processing information having a weight assigned on the color data format, to which the scanner conforms, is stored.

The CPU 16 indicates main control of the scanner 100 and instructs the individual component sections to perform a reading operation. When the user selects a printer for printing out by using the operation panel, the CPU 16 accepts information indicating the selected printer and instructs to obtain specific information of the printer connected through an output interface. The CPU 16 also instructs the image generation section 13 and the compression processing section 14 to execute image generation and compression processing.

The operation panel 17 is a user interface which is used by the user to instruct reading of printed documents and to instruct printing by the printer. The operation panel 17 is provided with a display on which a list of selectable printers is shown and an input section which is used by the user to give instructions (not shown).

The output interface A18 and the output interface B19 indicate cable interfaces of different standards such as an Ethernet (registered trademark) cable and a USB cable. But, intercommunication with the printer can be realized by wireless other than by a cable.

Image data to be sent to the printer in the above-described structure is generated as follows.

When the user uses the operation panel 17 to select a printer for printing out among the connected printers and instructs reading of printed documents, information of the selected printer is notified to the CPU 16. The CPU 16 having received the information obtains specific information of the printer including information indicating a corresponding color data format and information indicating a compression format of image data from the printer through the connected output interface by using a PJL (Printer Job Language) and stores it in the memory 15.

After the information is stored in the memory 15, an instruction to start reading is sent from the CPU 16 to the read section 10, and printed documents are read by the read section 10. The read image data is sent to the image generation section 13 through the input interface 11 of the scanner controller 12. The image generation section 13 refers to information of the color data format of the printer selected by the user stored in the memory 15 to generate image data according to the information of the color data format and to store in the memory 15 at the same time.

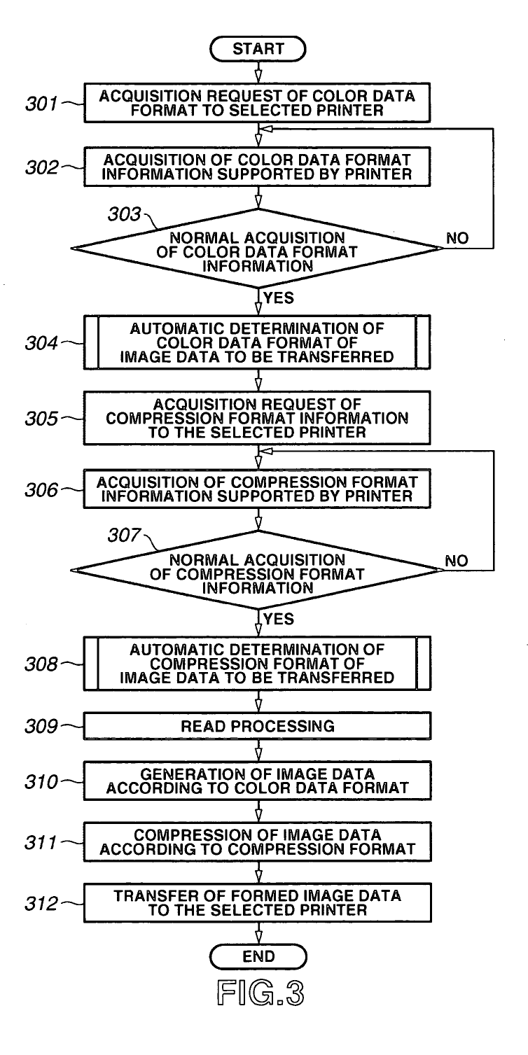

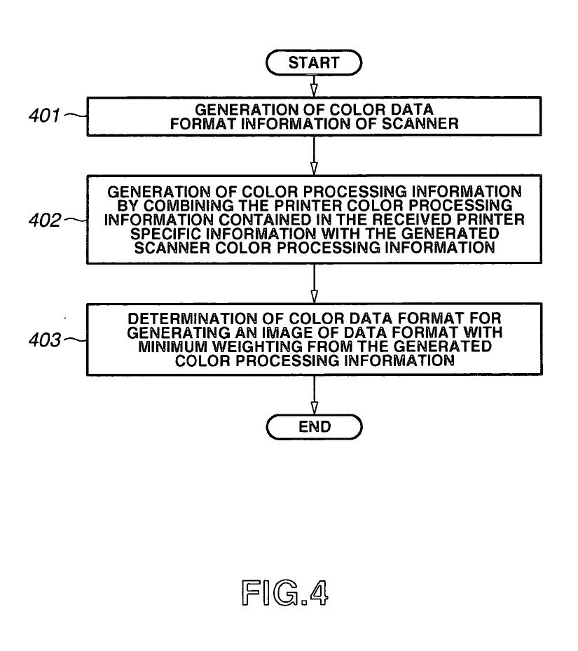

At this time, if information of plural color data formats is stored, a color data format of image data to generate a color data format selected by selection processing of an optimum color data format by weighting indicated in the flow charts shown in FIG. 3 and FIG. 4 is decided.

In addition, when the CPU 16 refers to the compression format stored in the memory 15 and designates the compression format (not non-compression), it instructs the compression processing section 14 to perform compression processing of the image data stored in the memory 15. The compression processing section 14 having received the instruction refers to the compression format stored in the memory 15 and compresses the image data according to the compression format.

The compressed image data is stored in the memory 15, and the image data is sent by the instruction from the CPU 16 to the printer through the output interface to which the printer is connected.

It may be configured that the color data format information and the specific information of the printer including the compression format are obtained from an MIB (Management Information Base) using an SNMP (Simple Network Management Protocol) if the printer is connected to a network.

It is configured to previously hold the scanner color processing information in the memory 15, but it may be configured to generate the scanner color processing information by the image generation section 13 upon receiving the read instruction. An example of scanner color processing information generated is shown in FIG. 6A.

Accordingly, an image can be formed according to the color data format of each printer selected by the user, and the image data can be compressed in the compression format supported by the printer. In other words, the image data can be converted into an optimum format according to the printer used for printing out.

FIG. 3 is a flow chart showing a flow of processing to generate an image by a scanner.

In FIG. 3, processing is started when the user selects a printer for printing out and instructs to read printed documents. The selected printer requests to obtain printer color processing information which is information of a corresponding color data format (S301). The printer color processing information included in the specific information of the printer is obtained (S302). At this time, the printer color processing information includes a color data format to which the printer conforms. If the printer corresponds to plural color data formats, prescribed weighting is made on the individual color data formats. An example of weighting is shown in FIG. 6B.

Then, it is judged whether printer color processing information including color data format information could be properly obtained (S303), and if it could not be obtained (NO in S303), an acquisition request is sent again to obtain the printer color processing information. At this time, if printer color processing information could not be obtained normally by repeating a reacquisition request for a specified number of times, error information is indicated, and the processing is terminated.

Meanwhile, if the printer color processing information could be obtained normally (YES in S303), a color data format of the read image data is automatically decided according to the obtained printer color processing information and the scanner color information held by the scanner (S304).

Then, an acquisition request for compression format information included in the printer specific information held by the selected printer is made (S305), and compression format information is obtained (S306). At this time, it is judged whether the compression format information could be obtained normally (S307), and if not (NO in S307), an acquisition request is sent again to obtain the compression format information. Similar to the above-described acquisition of the color data format information, if the information cannot be obtained by repeating the acquisition request for the specified number of times, error information is indicated, and the processing is terminated.

When the compression format information is obtained normally (YES in S307), a compression format of the image data is automatically determined from the obtained compression format information (S308). It may be configured to obtain the color data format information and the compression format information at the same time.

When the above information is obtained normally, the printed documents are read (S309), and image data is generated according to the decided color data format (S310), and the generated image data is compressed according to the compression format (S311). And, the generated image data is transferred to the printer selected by the user (S312).

FIG. 4 is a flow chart showing a flow of processing to make automatic determination of a color data format of a scanner.

In FIG. 4, processing is started when the color data format is obtained from the printer selected by the user, scanner color processing information is generated (S401) by the processing shown in FIG. 6A and combined with the printer color processing information received from the selected printer and stored in memory to generate the color processing information used between the selected printer and the scanner (S402).

In the generated color processing information, a color data format with a minimum value that weighting is not zero is determined as a color data format of the image data (S403).

Thus, the color data format of the image data to be sent to the printer can be determined automatically.

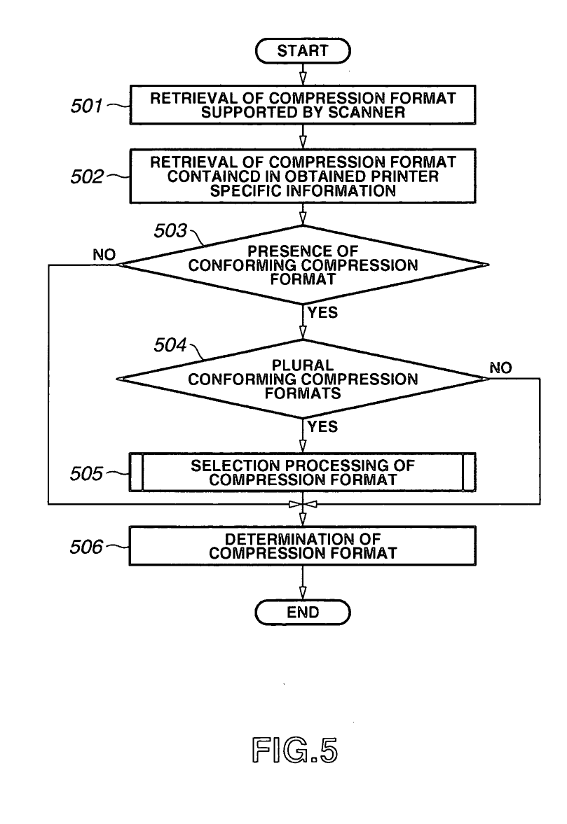

FIG. 5 is a flow chart showing a flow of processing to make automatic determination of the compression format of the scanner.

In FIG. 5, processing is started when the compression format is normally obtained from the printer selected by the user, and scanner compression processing information which is information of the compression format supported by the scanner is obtained (S501). And, printer compression processing information which is information of the compression format included in the obtained printer specific information is obtained (S502).

It is judged from the obtained scanner compression processing information and printer compression processing information whether there is a conforming compression format (S503). If there is at least one compression format (S504), it is judged whether there are plural conforming compression formats (S504). If the scanner compression processing information and the printer compression processing information each support plural compression formats and at least two of them conform to each other (YES in S504), a compression format is selected from the conforming plural compression formats considering a bandwidth, a transmission loss rate and a throughput (a workload per unit time) of the scanner and the printer (S505).

If there is not a conforming compression format in the scanner compression processing information and the printer compression processing information (NO in S503), the compression format is determined to be non-compression (S506). If there is one conforming compression format in the scanner compression processing information and the printer compression processing information (NO in S504), the conforming compression format is determined as a compression format for the image data (S506). When the compression format selection processing is conducted (S505), the selected compression format is determined to be a compression format for image data (S506).

Thus, a compression format of image data to be sent to the printer can be determined automatically.

FIG. 6A through FIG. 6C are views showing an example of color processing information to determine a color data format.

FIG. 6A shows scanner color processing information held by the scanner, FIG. 6B shows the printer color processing information obtained from the printer, and FIG. 6C shows color processing information to determine the color data format of image data from information shown in FIG. 6A and FIG. 6C.

The color processing information shown in FIG. 6C shows data obtained by merging the scanner color processing information of FIG. 6A and the printer color processing information of FIG. 6B by combining them for each color data format.

For example, in the scanner color processing information shown in FIG. 6A, a processing cost (601) indicating a quantified weight of “point sequence” shows “100”, a processing cost (602) of “line sequence” shows “200”, and a processing cost (603) of “plane sequence” shows “210”; and in the printer color processing information shown in FIG. 6B, a processing cost (611) of “point sequence” shows “200”, a processing cost (612) of “line sequence” shows “100” and a processing cost (613) of “plane sequence” shows “0”.

The processing cost “100” which is a quantified weight indicates an optimum color data format capable of transferring image data without performing conversion processing, the processing cost “200” indicates a color data format which is required to be subject to conversion processing, and the processing cost “210” indicates that the conversion processing is required and the cost is higher than the color data format of the processing cost “200”.

And, processing cost “0 (zero)” indicates that the scanner or the printer does not conform to the pertinent color data format.

The color processing information shown in FIG. 6C is generated by combining the processing costs of the color data formats of the printer color processing information and the scanner color processing information on which the processing cost is weighted.

As a result, a processing cost (621) of “point sequence” of the color processing information becomes “20000” as shown in FIG. 6C, a processing cost (622) of “line sequence” becomes “20000” and a processing cost (623) of “plane sequence” becomes “0”.

If there are plural color data formats with the same processing cost, the processing cost of either the scanner or the printer is given a high priority, so that the color data formats can be determined uniquely even if they have the same processing cost.

In the above-described example, when it is determined that the processing cost of the scanner is given a high priority (color data format having the processing cost “100” of the scanner is given a high priority), “point sequence” is determined as color data format.

Thus, the color data format is determined uniquely.

FIG. 6A shows scanner color information which is previously held in the scanner but it may be configured to generate as follows.

As an example of generating scanner color information, if a default data format of data read from the read section shown in FIG. 2 is “point sequence”, when the color data format to be converted by the image generation section through the input interface is “point sequence” and the transfer to the printer can be made without conducting the conversion processing, it can be judged as an optimum color data format, so that a processing cost for weighting is set to “100”.

Then, the scanner conforms to the “line sequence” and the “plane sequence” of the color data format, but the format conversion processing is required because it is not a default data format. Therefore, the processing cost becomes heavier in comparison with the “point sequence”. At this time, the processing cost is determined to be “200”, but the processing cost of “line sequence” is determined to be “200” and the processing cost of “plane sequence” is determined to be “210” to provide the priority by “line sequence” and “plane sequence”.

Thus, scanner color processing information can be generated at the time of turning on the scanner, or the like.

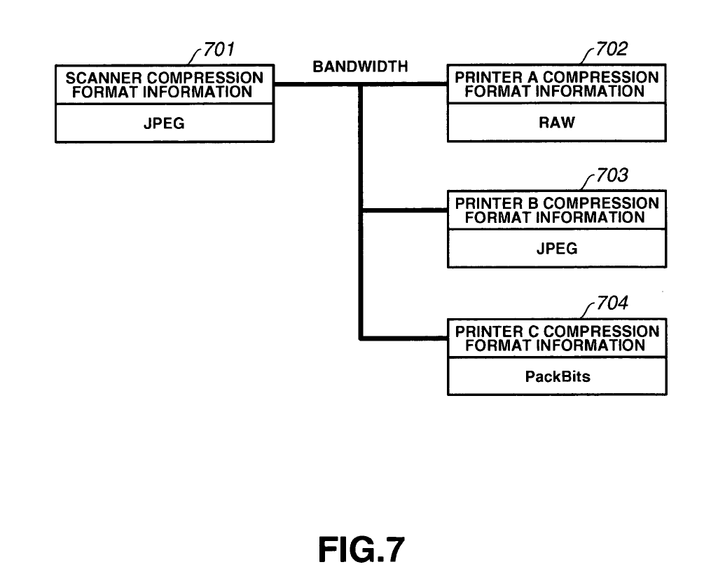

FIG. 7 is a view showing an example of color processing information to determine a compression format.

FIG. 7 shows scanner compression format information 701 indicating a compression format which is supported by the scanner, printer A compression format information 702 indicating a compression format to which the printer A connected to the scanner conforms, printer B compression format information 703 indicating a compression format to which printer B conforms and compression format information 704 to which the printer C conforms.

Where the user selects the printer A as a printer to print out, compression is not made by “JPEG” supported by the scanner because the printer A supports “RAW” which is not compressed, and image data is transferred in a non-compression state. If the printer B is selected, image data is compressed in JPEG and transferred because of the same compression format “JPEG” as the scanner. If the printer C is selected, the image data is transferred in a non-compression state because of a compression format “PackBits” not supported by the scanner.

An example of the compression format information shown here corresponds to only one compression format, but the scanner and the printer may conform to plural compression formats. In this case, if the compression format is provided with a priority depending on compression efficiency, compression processing time and the like, the compression is made in a compression format with the highest priority and, if plural compression formats are supported, the priority of either the scanner or the printer is given a priority, so that the compression format can be specified uniquely.

By processing as described above, image data which is converted into the color data format to which the printer conforms can be transferred.

Thus, there is an effect that printing can be made by a desired printer with no consciousness of the user regarding the specifications of data formats variable depending on the printers connected to the scanner.

And, the image data can be compressed in the compression format to which the selected printer conforms and transferred, so that the image data can be transferred with the line load of the connected data line suppressed to the minimum.

In addition, the transmission loss rate can be suppressed to the minimum because a ratio occupying the line is decreased, and there is also an effect capable of realizing high-speed transfer.

### Embodiment 2

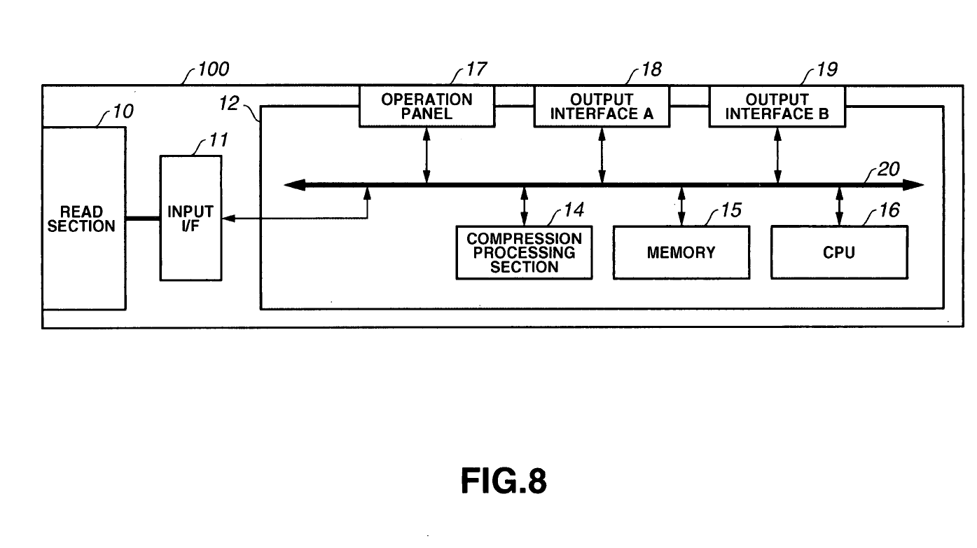

FIG. 8 is a view of another system structure example configured by applying an image forming system, an image forming method and an image reading device according to an aspect of the present invention.

FIG. 8 illustrates different portions mainly because there are many similar portions as those in the system structure view shown in FIG. 1.

In FIG. 1, it is configured to generate image data by the image generation section 13 with respect to the data read by the read section 10. In FIG. 8, it is configured that printed documents are converted into electrical signals for individual light receiving elements (pixels) by the read section 10 which is comprised of a CCD (Charge Coupled Device) or the like which optically reads and the image data is converted into the designated color data format at the same time.

Because the image data is electrically (by hardware) converted by an electric circuit element, conversion can be made at a high speed even when a color data format is required to be converted.

Thus, the image generation section 13 shown in FIG. 1 can be eliminated.

When a printer is selected by the user and specific information of the printer is obtained and stored in the memory 15, the CPU 16 instructs the read section 10 to read the printed documents and also transfers information of the color data format of the printer specific information stored in the memory 15. According to the information, the read section 10 reads the printed documents and converts into the transferred color data format.

By processing as described above, a storage area in the memory 15 for the image generation is required, so that a memory size can be reduced, providing an effect that the production cost can be reduced.

There are also produced effects that processing efficiency and processing speed for electrical conversion are remarkable, and high-quality image data can be generated.

As described above, a first aspect of the present invention provides an image forming system including an image reading device and a printing device which are connected together through a communication unit, for transmitting image data read by the image reading device to the printing device through the communication unit to print out, in which the image reading device includes: an information acquisition unit which obtains a print image data format processable by the printing device through the communication unit; a management unit which stores and manages the print image data format obtained by the information acquisition unit in correspondence with the printing device; a selection unit which selects a printing device which instructs to print the image data read by the image reading device; a conversion unit which refers to the print image data format managed by the management unit and converts the image data read by the image reading device into a print image data format optimum for the printing device selected by the selection unit; and a transmission unit which sends the image data in the print image data format converted by the conversion unit to the printing device through the communication unit, and in which the printing device includes: a receiving unit which receives the image data sent by the transmission unit; and a print processing unit which performs printing according to the image data received by the receiving unit.

A second aspect of the present invention provide the image forming system according to the first aspect of the invention, in which the information acquisition unit may detect a communication method communicable with the printing device and uses the detected communication method to obtain from the printing device the print image data format processable by the printing device, and the management unit may manage the communication method in correspondence with the printing device.

A third aspect of the present invention provides the image forming system according to the first aspect of the invention, in which the information acquisition unit may obtain a compression format which is used in the print image data format and which can be interpreted by the printing device; the management unit may manage the obtained compression format in correspondence with the printing device; and the conversion unit may compress the image data read by the image reading device in a compression format optimum for the printing device selected by the selection unit.

A fourth aspect of the present invention provides the image forming system according to the first or second aspect of the invention, in which the information acquisition unit may obtain an image format which is used in the print image data format and which can be interpreted by the printing device; the management unit may manage the obtained compression format in correspondence with the printing device; and the conversion unit may convert the image data read by the image reading device in an image format optimum for the printing device selected by the selection unit.

A fifth aspect of the present invention provides the image forming system according to the fourth aspect of the invention, in which the image format may be a color data format of any of point sequence, line sequence or plane sequence.

A sixth aspect of the present invention provides the image forming system according to any of the first to fifth aspect of the invention, in which the conversion unit may convert the image data read by the image reading device into a print image data format optimum for the printing device selected by the selection unit at the time of reading an image by the image reading device.

A seventh aspect of the present invention provides the image forming system according to the first aspect of the invention, in which the image reading device may further include a data format holding unit which previously holds a print image data format capable of converting the read image data together with numerical values which are weighted for individual print image data formats; the information acquisition unit may obtain plural print image data format information being held by the printing device; the management unit manages the individual print image data formats of the printing device obtained by the information acquisition unit together with the weighted numerical values; and the conversion unit may convert the image data according to a print image data format having an optimum numerical value by combining for each data format a numerical value of each convertible print image data format held by the data format holding unit and a numerical value of each print image data format stored by the management unit.

An eighth aspect of the present invention provides the image forming system according to the seventh aspect of the invention, in which the data format holding unit may hold the print image data formats by assigning a priority order; and the conversion unit may convert the image data by a print image data format with a highest priority which is held by the data format holding unit if there are print image data formats having the same combined numerical value.

A ninth aspect of the present invention provides an image forming method using an image reading device and a printing device which are connected together through a communication unit, for sending image data read by the image reading device to the printing device through the communication unit and printing out, the method including: obtaining, by an information acquisition unit of the image reading device, a print image data format processable by the printing device through the communication unit; storing and managing, by a management unit of the image reading device, the print image data format which is obtained by the information acquisition unit in correspondence with the printing device; selecting, by a selection unit of the image reading device, a printing device which instructs printing of the image data read by the image reading device; referring to a print image data format managed by the management unit and converting, by a conversion unit of the image reading device, the image data read by the image reading device into a print image data format optimum for the printing device selected by the selection means; and sending, by a transmission unit of the image reading device, image data in the print image data format converted by the conversion unit to the printing device through the communication unit; receiving, by a receiving unit of the printing device, the image data which is sent by the transmission unit; and conducting print processing according to the image data received by the receiving unit.

A tenth aspect of the present invention provides an image reading device which sends read image data to a printing device by a communication unit to print out, and which includes: an information acquisition unit which obtains a print image data format processable by the printing device through the communication unit; a management unit which stores and manages the print image data format obtained by the information acquisition unit in correspondence with the printing device; a selection unit which selects a printing device which instructs to print the image data read by the image reading device; a conversion unit which refers to a print image data format managed by the management unit and converts the image data read by the image reading device into a print image data format optimum for the printing device selected by the selection unit; and a transmission unit which sends the image data in the print image data format converted by the conversion unit to the printing device through the communication unit.

The present invention is not limited to the embodiments described above and shown in the drawings and various modifications may be made without deviating from the spirit and scope of the invention.

The present invention can be applied to an image forming system which prints out the printed documents read by the scanner by the connected printer, and it is particularly useful for printing in an environment that plural printers are connected with no consciousness of the user regarding the specifications different for printers desired by the user.

The foregoing description of the embodiments of the present invention has been provided for the purpose of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling other skilled in the art to understand the invention for various embodiments and with the various modifications as are suited to the particular use contemplated. It is intended that the scope of the invention be defined by the following claims and their equivalents.

The entire disclosure of Japanese Patent Application No. 2005-81692 filed on Mar. 22, 2005 including specification, claims, drawings and abstract is incorporated therein by reference in its entirety.

1. An image forming system including an image reading device and a printing device which are connected together through a communication unit, for transmitting image data read by the image reading device to the printing device through the communication unit to print out, wherein:
the image reading device comprises:
an information acquisition unit which obtains a print image data format processable by the printing device through the communication unit;
a management unit which stores and manages the print image data format obtained by the information acquisition unit in correspondence with the printing device;
a selection unit which selects a printing device which instructs to print the image data read by the image reading device;
a conversion unit which refers to the print image data format managed by the management unit and converts the image data read by the image reading device into a print image data format optimum for the printing device selected by the selection unit; and
a transmission unit which sends the image data in the print image data format converted by the conversion unit to the printing device through the communication unit, and wherein:
the printing device comprises:
a receiving unit which receives the image data sent by the transmission unit; and
a print processing unit which performs printing according to the image data received by the receiving unit.

2. The image forming system according to claim 1, wherein:
the information acquisition unit detects a communication method communicable with the printing device and uses the detected communication method to obtain from the printing device the print image data format processable by the printing device, and
the management unit manages the communication method in correspondence with the printing device.

3. The image forming system according to claim 1, wherein:
the information acquisition unit obtains a compression format which is used in the print image data format and which can be interpreted by the printing device,
the management unit manages the obtained compression format in correspondence with the printing device, and
the conversion unit compresses the image data read by the image reading device in a compression format optimum for the printing device selected by the selection unit.

4. The image forming system according to claim 1, wherein:
the information acquisition unit obtains an image format which is used in the print image data format and which can be interpreted by the printing device,
the management unit manages the obtained compression format in correspondence with the printing device, and
the conversion unit converts the image data read by the image reading device in an image format optimum for the printing device selected by the selection unit.

5. The image forming system according to claim 2, wherein:
the information acquisition unit obtains an image format which is used in the print image data format and which can be interpreted by the printing device,
the management unit manages the obtained compression format in correspondence with the printing device, and
the conversion unit converts the image data read by the image reading device in an image format optimum for the printing device selected by the selection unit.

6. The image forming system according to claim 4, wherein the image format is a color data format of any of point sequence, line sequence or plane sequence.

7. The image forming system according to claim 5, wherein the image format is a color data format of any of point sequence, line sequence or plane sequence.

8. The image forming system according to claim 1, wherein the conversion unit converts the image data read by the image reading device into a print image data format optimum for the printing device selected by the selection unit at the time of reading an image by the image reading device.

9. The image forming system according to claim 1, wherein:
the image reading device further comprises a data format holding unit which previously holds a print image data format capable of converting the read image data together with numerical values which are weighted for individual print image data formats;
the information acquisition unit obtains plural print image data format information being held by the printing device;
the management unit manages the individual print image data formats of the printing device obtained by the information acquisition unit together with the weighted numerical values; and
the conversion unit converts the image data according to a print image data format having an optimum numerical value by combining for each data format a numerical value of each convertible print image data format held by the data format holding unit and a numerical value of each print image data format stored by the management unit.

10. The image forming system according to claim 9, wherein:
the data format holding unit holds the print image data formats by assigning a priority order; and
the conversion unit converts the image data by a print image data format with a highest priority which is held by the data format holding unit if there are print image data formats having the same combined numerical value.

11. An image forming method using an image reading device and a printing device which are connected together through a communication unit, for sending image data read by the image reading device to the printing device through the communication unit and printing out, comprising:
obtaining, by an information acquisition unit of the image reading device, a print image data format processable by the printing device through the communication unit;
storing and managing, by a management unit of the image reading device, the print image data format which is obtained by the information acquisition unit in correspondence with the printing device;
selecting, by a selection unit of the image reading device, a printing device which instructs printing of the image data read by the image reading device;
referring to a print image data format managed by the management unit and converting, by a conversion unit of the image reading device, the image data read by the image reading device into a print image data format optimum for the printing device selected by the selection means; and
sending, by a transmission unit of the image reading device, image data in the print image data format converted by the conversion unit to the printing device through the communication unit;
receiving, by a receiving unit of the printing device, the image data which is sent by the transmission unit; and
conducting print processing according to the image data received by the receiving unit.

12. An image reading device which sends read image data to a printing device by a communication unit to print out, comprising:
an information acquisition unit which obtains a print image data format processable by the printing device through the communication unit;
a management unit which stores and manages the print image data format obtained by the information acquisition unit in correspondence with the printing device;
a selection unit which selects a printing device which instructs to print the image data read by the image reading device;
a conversion unit which refers to a print image data format managed by the management unit and converts the image data read by the image reading device into a print image data format optimum for the printing device selected by the selection unit; and
a transmission unit which sends the image data in the print image data format converted by the conversion unit to the printing device through the communication unit.

13. The image forming system according to claim 2, wherein the conversion unit converts the image data read by the image reading device into a print image data format optimum for the printing device selected by the selection unit at the time of reading an image by the image reading device.

14. The image forming system according to claim 3, wherein the conversion unit converts the image data read by the image reading device into a print image data format optimum for the printing device selected by the selection unit at the time of reading an image by the image reading device.

15. The image forming system according to claim 4, wherein the conversion unit converts the image data read by the image reading device into a print image data format optimum for the printing device selected by the selection unit at the time of reading an image by the image reading device.

16. The image forming system according to claim 5, wherein the conversion unit converts the image data read by the image reading device into a print image data format optimum for the printing device selected by the selection unit at the time of reading an image by the image reading device.

17. The image forming system according to claim 6, wherein the conversion unit converts the image data read by the image reading device into a print image data format optimum for the printing device selected by the selection unit at the time of reading an image by the image reading device.

18. The image forming system according to claim 7, wherein the conversion unit converts the image data read by the image reading device into a print image data format optimum for the printing device selected by the selection unit at the time of reading an image by the image reading device.
